(19) United States
(12) Patent Application Publication
(10) Pub. No.: US 2015/0056037 A1
(43) Pub. Date: Feb. 26, 2015

(54) METHOD AND APPARATUS FOR SCULPTING PARTS AND PARTS MADE THEREFROM

(71) Applicant: Alexander Wilson, Surprise, AZ (US)

(72) Inventor: Alexander Wilson, Surprise, AZ (US)

(21) Appl. No.: 14/217,129

(22) Filed: Mar. 17, 2014

Related U.S. Application Data
(60) Provisional application No. 61/869,708, filed on Aug. 25, 2013.

(51) Int. Cl. B23D 5/02; B23D 7/06

(52) U.S. Cl. CPC B23D 5/02; B23D 7/06
USPC 409/289; 428/156; 428/141

(57) ABSTRACT

A sculpting machine, a method of sculpting a work-piece and work-products produced therefrom are described. A sculpting machine provides a cutting tool holder that is configured to hold a cutter in contact with a work-piece and move in two or more planes or axes of controlled motion about the work-piece to remove material. The cutter is non-spinning and is held in contact with the work-piece to carve away material, or sculpt the work-piece. The cutter may be held against the work-piece with the cutter in a fixed orientation relative to the surface of the work-piece being cut. The cutter may be moved along a straight line, curve or arc. The resulting product produced may have a much tighter tolerance and smoother surface finish than products machined with conventional techniques.

### CROSS REFERENCE TO RELATED APPLICATIONS

This application claims the benefit of U.S. provisional patent application no. 61/869,708, filed on Aug. 25, 2013 and entitled Method and Apparatus for Sculpting Parts and Parts Made Therefrom, of which the entirety is incorporated by reference herein.

### BACKGROUND OF THE INVENTION

1. Field of the Invention

The present invention relates to a unique sculpting machining method, an apparatus for sculpting parts and parts made therefrom.

2. Background

The current way of machining parts with a computerized numerical control, CNC, milling machine utilizes spinning cutting tools. The cutting tools, which are comprised of end mills, face mills, drills, etc., are designed to spin in a spindle of a CNC machine. The speed at which they spin is determined by the type of material being machined and also by the physical limitation of the machine. Typical spindle spinning speeds range from 10 rpm to about 30,000 rpm. While a spinning cutting tool does the job of removing material fairly well, it performs poorly when making final dimensional cuts and thus produces a rough, and in many cases, an unacceptable finish. Therefore, the parts produced require additional processes to bring the surface finish to an acceptable standard. The additional processes include sanding, buffing, polishing and/or grinding.

Machining of parts, such as metal pieces requiring a specific shape, is typically accomplished using a computerized numerical control milling machine. CNC milling machines comprise a tool holder that is configured to spin a tool, such as a cutting tool, having one or more cutters configured to remove metal as it spins. This type of machining produces interrupted cuts, where chips, or discrete pieces of metal, are chipped off the work-piece as the cutting tool is moved in relation to the work-piece. In many cases, a cutting tool has one or more cutter inserts that are configured to be replaceable. A cutter may have one or more cutter inserts whereby the cutter insert may be detached from the cutting tool and reconfigured to provide a fresh cutting surface. Interrupted cutting dulls cutters very quickly and cutters are routinely replaced or reconfigured to provide adequate cutting. This frequent stopping of the machine to remove and/or change out cutters reduces the efficiency of machining parts.

The revolutions per minute (rpm) of the spinning cutting tool depends on the type of metal and the condition and type of cutting tool used. In addition, a cutting tool has a limited speed at which it can be moved relative to a work-piece when removing metal. The surface finish of a work-piece, after having a layer of metal removed using a conventional spinning cutter, is relatively rough. There are typically striations left in the material from the cutters, and these surface anomalies typically have to be buffed out, requiring more time to complete the work-product. Conventional aerospace industry tolerance of work-products produced with a spinning cutting tool are typically +0.020 inches and −0.010 inches and the surface roughness is typically 1.6 to 3.2 μm RA or more. The typical thickness of a web in an aircraft component is 0.100 inch. Therefore, a web thickness could vary between 0.090 and 0.120 inch. An aircraft being designed must be able to support parts made on the high side of the tolerance as well as the low side of the tolerance. It is conceivable that an aircraft designed to weigh 10,000 pounds could weigh as much as 12,000 pounds or as little at 9,000 pounds. A process that produces closer tolerance parts may allow for reduced overall weight of the craft.

### SUMMARY OF THE INVENTION

The invention is directed to a unique machining method that enables sculpting of parts by contacting the work-piece with a cutter and moving it along the work-piece to remove material without spinning the cutter. The result is a much smoother finish and a work-product that requires very little de-burring and little to no post machining polishing. The finish produced by the sculpting method, as described herein, can be gem-like quality with surface roughness of less than 1 μm RA or even less than about 0.4 um RA. A mirror finish can be produced by this unique sculpting technique. In addition, this new method produces much less wear on cutters, creates less noise, and produces a higher tolerance work-product than spinning cutter tool CNC methods. The method of the present invention utilizes a cutting tool that is held in a relative fixed position, non-spinning, to a work-piece surface and is moved relative to the work-piece surface to carve off a layer of material. The cutter may be moved along the surface of the work-piece in a tangential geometry and moved around contours or arcs of the work-piece to peel away a ribbon of material. The cutter may be programmed to rotate or index as the cutter moves along an arc or curve to maintain proper cutting orientation of the cutter. In the sculpting method of the present invention, the cutter does not spin relative to the surface to be cut to cause intermittent contact with the work-piece as is the case with conventional spinning mill cutters used in a CNC machine. In the sculpting method of the present invention, the cutter may remain in continuous contact with the work-piece to remove material from two or more planes of the work-piece. Put another way, the cutter may be moved relative to the work-piece in two or more axis to remove material in a continuous fashion, whereby the cutter continuously peels away a layer, or ribbon of material from a work-piece.

The material removed usually comes off as a ribbon, whereby the cutter surface is held in contact with the work-piece to provide a continuous cut. Since the cutter is not spinning relative to the work-piece, striations in the machined surface are virtually eliminated. In addition, the cutting method of the present invention produces very little noise, since the cutters are not impacting the metal repeatedly to remove discrete chips of material. It is conceived that any suitable depth of cut may be utilized with the method of the present invention and is dependent upon the type of material, the cutting tool used and the stability of the machine. Deep cuts would require a machine with enough rigidity to handle the high thrust loads in the axis of cutting.

The machining method of the present invention can be operated at much higher feed rates than a traditional spinning cutter method. In the present invention, the cutter may be moved across the surface of the work-piece with a very high feed rate depending on the type of material. Feed rate is the relative forward speed of the cutter relative to the work-piece. Surface feet per minute is the actual speed of a cutter edge relative to the surface of a work-piece. Conventional spinning cutters have a high rotation speed but typically have a relative low feed rate. For example, titanium is a very poor thermal conducting material which limits the maximum surface feet per minute of a cutter to approximately 135 surface feet per minute. Spinning cutters offer high surface feet per minute but require a relatively low feed rate such as 6 inches/min for titanium. A cutter used in the sculpting method of the present invention can be moved at a much higher feed rate when cutting titanium and can have a feed rate of 400 inches/min, 1000 inches/min or as high as 1620 inches/min which is equivalent to the 135 surface feet per minute, the typical limit for titanium. For other materials, such as aluminum and other more thermally conductive metals, wood, plastic, and the like, the cutter of the present invention may be moved at very high feed rates including, but not limited to, about 1000 inches min or more, about 1500 inches/min or more, 2000 inches/min or more, 4000 inches/min or more and any range between and including the feed rates provided.

The high tolerance achievable by the sculpting machining method of the present invention may allow for overall reduction in the weight capacity designed into articles made therefrom, such as aircraft. As described in the background, the conventional CNC methods routinely produce parts with a tolerance of +0.020″ and −0.010″. The current method can easily produce parts with a tolerance of +0.002″ and −0.001″. This reduction in the tolerance would provide for an aircraft, as described in the background, to have a weight range of 10,200 pounds to 9,900 pounds. Therefore an aircraft would be a more precise instrument being able to carry a larger payload and/or able to achieve higher speed with greater agility. Furthermore, the aircraft could be designed to be lighter due to the fact that the maximum weight of its components are more precisely controlled. This also would translate to more fuel efficiency, higher speeds, greater agility, and larger payloads.

A sculpting cutting method, as described herein, causes far less wear on cutters and cutting surfaces. Therefore, more time is spent removing material from the work-piece and less is spent maintaining a sharp cutting surface or edge. This reduction in change-out times contributes to higher efficiencies and rates of machining parts of the sculpting machining method of the present invention. A work-product may be produced with the sculpting machining method of the present invention in one-half, one-third, or in some cases one-quarter or less of the time than the conventional spinning cutter method.

In one embodiment, the method of machining a work-product comprises the steps of: placing a work-piece into a sculpting machine, as described herein, having computerized numerical control capability; and securing a cutting tool in a cutting tool holder and moving the cutting tool tangentially across the work-piece surface to cause the cutting tool to carve off a ribbon of said work-piece. The ribbon removed from the work-piece may be a continuous ribbon having a length of at least 3 inches or more, or having a length from a first end of a work-piece to a second end of a work-piece. A continuous layer of material may be removed from a surface of the work-piece. The cutter may then be rotated and moved down relative to the work-piece to allow another ribbon of material to be removed. Again, the cutter may be moved at a very high rate of speed enabling a large amount of material to be removed in a very short amount of time. The cutter may be moved from one plane of the work-piece to a second plane of the work-piece and remove a continuous ribbon therefrom. The sculpting machine and method of the present invention enables a cutter to be brought into contact with a work-piece and moved about the work-piece in any number of different planes including around curves or arcs to remove a ribbon of material. The cutter may stay in continuous contact with the work-piece for any suitable amount of time as dictated by the part being machined. As an example, a cutter may be brought into contact with a work-piece and moved at a feed rate of approximately 400 inches/min for 4 minutes and remove material from two or more axis of controlled motion to produce a 1600 inch long continuous ribbon. It is to be understood that the ribbon would break into segments as it extends away from the cutter; however the ribbon produced by the cutter is continuous.

The cutter used may be any suitable type of cutter and comprise one or more cutter surfaces or edges, or cutter inserts which may be configured on a cutter body. In one embodiment, the cutter is moved from a first end of a work-piece to a second end of work-piece with a first cutter surface engaged and in continuous contact with the work-piece to remove a ribbon of material. The cutting tool may then be indexed or moved in an axis of controlled motion and then moved back across the work-piece, whereby a second cutter surface engages the work-piece to remove a second ribbon. The process may be repeated to remove a layer of material across a surface of a work-piece. In an alternate embodiment, the cutting tool holder may rotate the cutter approximately 180 degrees whereby the same cutter may be engaged with the work-piece when moved back across the work-piece. The sculpting machine of the present invention may have means of registering the cutter position, including the rotational position, whereby the control system can move or rotate the cutter as required for sculpting a work-piece.

A sculpting machine, as described herein, may be configured with any suitable type of movable work-piece restraint, whereby the work-piece may be moved in an X-axis, Y-axis, Z-axis, and/or rotated about any of these axes. The work-piece restraint may be moved by the sculpting machine in any of the axes in a controlled motion. A work instruction may direct the work-piece restraint to move in the X-axis a distance of 20 cm and then in the Y-axis a distance of 40 cm, in a controlled motion manner. Likewise, a cutting tool holder may be configured to move in a suitable orientation including an X-axis, Y-axis, Z-axis, and rotated about any of these axes. The cutting tool holder, and subsequently a cutting tool restrained therein, may be moved by the sculpting machine in any of the axes described in a controlled motion, whereby the motion is controlled by the CNC machine portion of the sculpting machine.

In an exemplary embodiment, a work-piece restraint is configured to move in an X-axis, Y-axis and a work-piece restraint is configured to move in a Z-axis. Any combination of motions of the work-piece and the cutting tool may be utilized. In some embodiments, the work-piece restraint and the cutting tool holder move simultaneously in a controlled motion. This type of motion may be used to create arcs or curved cuts from the work-piece.

A CNC machine of the sculpting machine, described herein, comprises a user input configured to allow a user to program work instructions. Any series of motions may be programmable into the control system to automatically move the work-piece and/or cutter to sculpt a work-product. A CNC machine typically comprises one or more servomotors configured to move the work-piece restraint and/or a cutting tool. A work-piece restraint may be a table that is configured to move in the X-axis, Y-axis and/or Z-axis. A work-piece may be clamped or restrained to the work-piece restraint in any suitable fashion. In another embodiment, a work-piece restraint comprises a chuck configured to clamp into or around a portion of a work-piece. A work-piece may be configured to rotate about one or more linear axis.

A cutting tool or sculpting cutting tool may have one or more cutting surfaces and a cutter may be configured to be detachable and reconfigurable or replaceable. A cutter may have any suitable shape and dimensions. In one embodiment, a cutter is fixed to or part of a cutter body. In another embodiment a cutter is a cutter insert that is configured to be detachably attached to a cutter body. A cutter insert may have one, two, three or four cutting surfaces for example.

A cutting tool may be configured to move such that the cutting surface remains substantially tangential with the work-piece surface as it removes a ribbon of material. A cutting tool may be configured to move around an existing arced perimeter on a work-piece or to create a rounded surface having a radius on a work-piece. In many conventional CNC machines, the cutting tool is configured to spin at a high rate of speed to produce an interrupted cut, whereby discrete pieces of material are removed from a work-piece as the cutting tool is moved across the surface. This type of cutting tool arrangement requires bearings to allow for the high rpm of the cutting tool. The cutting tool holder of the present invention may be configured to hold the cutting tool in a more rigid fashion, whereby higher torque loads may be withstood, or withstood over an extended period of time. A tool “crash” occurs when a tool retained by the CNC machine moves into a work-piece at too high of a rate. A crash may be harmful to the machine, tools, or parts being machined, and in some cases results in bending or breakage of cutting tools, cutting tool holders, accessory clamps, vices, and fixtures. In severe cases, a crash may damage the machine itself and bend guide rails, break drive screws, or cause structural components to break. A cutting tool holder and cutting tool of the present invention may be configured to withstand and absorb high impact or thrust loads in all axes. A sculpting machine, as described herein, maybe configured to move a cutting tool holder to maintain the cutting surface substantially tangential with the surface of a work-piece and may be configured to rotate as required. Rotation of the cutting tool, as described herein, rotates the cutter to maintain contact of the cutter with the work-piece, whereas spinning of a cutter causes a cutter to have intermittent contact with the work-piece.

The sculpting machine and method of the present invention can be configured to machine any suitable type of material including, metal, wood, plastic, composites and the like. A work-piece may comprise, consist essentially of, or consist of any suitable type of metal, including steel, aluminum, copper, gold, silver, platinum, palladium, nickel, titanium, composites and the like. Likewise, a work-piece may comprise, consist essentially of, or consist of any suitable type of plastic. In an exemplary embodiment, the sculpting machine method, as described herein, can be used to machine super alloys, as known in the art, including, but not limited to Inconel, Waspaloy, Haspaloy and AF1410, and the like. Typical milling machining methods of super alloys can be expensive as they require frequent change out of cutters because the hardness of the alloys.

The sculpting method of machining, as described herein, with its non-interrupted cutting process which removes a continuous ribbon of material from said work-piece, is a far superior method for machining super alloys, such as Inconel, Waspaloy, Haspaloy and AF1410. The sculpting method of machining may easily remove approximately twelve cubic inches of material per minute of Carpenter alloy AF1410, which is a ferrous based alloy comprised of approximately 14% cobalt and 10% nickel. Under most conditions, the use of carbide end mills is not suitable for cutting Carpenter alloy AF1410 due to the primary characteristic of the end mill's interrupted cutting process which quickly breaks down the cutting edge. Standard high speed steel cobalt, HSS-Co, end mills, being more resilient, are better able to tolerate the interrupted cut process, especially when roughing excess metal from the work-piece, but require a significantly slower surface feet per minute than their counterpart carbide end mills. However, these high speed steel cobalt end mills are only capable of removing approximately one cubic inch of material per minute from a Carpenter alloy AF1410. The sculpting method of machining, which is suitable for use with carbide cutters due to the non-interrupted cutting process, may be capable of removing material from a Carpenter alloy AF1410 work-piece in less than one-tenth the time required by high speed steel cobalt end mills and less than one-fourth the time required by carbide end mills. This time savings translates into ten parts being machined by the sculpting process in the same time as only one part being machined by the conventional process of spinning HSS-Co end mills. Under the current method of using spinning end mills, the unit cost of cutter consumption to produce one part made from Carpenter alloy AF1410 is in excess of $50 per part. Using the sculpting method, as described herein, the unit cost of cutter consumption would be less than $5 per part.

The sculpting method of machining, as described herein, may be used to sculpt aluminum. It is common practice in the aerospace industry to machine aluminum components whereby one or more surfaces have three dimensional contouring. The conventional practice is to generate this three dimensional surface using spinning end mills that require multiple parallel passes along the surface, each time indexing a pass by approximately 0.040 to 0.080 inches. The surface finish produced by the conventional process is often 6.2 μm RA or more, or 12.4 μm RA or more. Preparing a final part after this conventional process requires hand working the surface using sanding discs or similar devices to smooth the striations left by the multiple passes and interrupted cutting method. The sculpting method of machining, due to its exceedingly high feed rate, can be configured to complete a pass across aluminum in one-fourth the time, one-eighth the time, and in some cases one-sixteenth the time of the conventional process, thereby making it possible to limit the indexing of each pass to 0.010, or 0.005, or even 0.002 inches, without increasing machine time. The sculpting method of machining also reduces or requires no hand work of the surface to remove striations. The surface finish produced by the sculpting method of machining may be less than about 1.6 μm RA, less than about 0.8 μm RA, and in some cases less than about 0.4 μm RA. The surface of an aluminum part made by a sculpting method of machining, as described herein, may have a far superior surface finish and dimensional accuracy to the conventional milling machining method.

The sculpting method of machining, as described herein, may be used to create a T-slot, ball, shell or square as further described herein. A T-slot is a portion of material removed from a work-piece, below the surface of the work-piece having a width that is wider than the cutting tool entry slot. A ball is a rounded groove removed from a work-piece. A shell is a square or rectangular portion removed from a work-piece. A square is square portion of material removed from a corner of a work-piece. Any suitable type of sculpting arrangements may be envisioned. A continuous ribbon may be removed from a work-piece that is equal to or greater than the length, width or distance from a first end to a second end of a work-piece.

A series of program instructions may be provided that maintains contact of the cutting surface with the work-piece over two or more directional paths. A directional path has a linear axis of motion. In one embodiment, a method of machining a work-product, as described herein, comprises programmable work instructions with a plurality of movements of the work-piece in an X-axis and a Y-axis, wherein continuous layers of the work-piece are removed in both said X-axis and said Y-axis to create a work-product. In some embodiments, essentially the entire outer surface of the work-product has been sculpted by the method described herein. A work-product produced by the sculpting method, described herein, may comprise any suitable percentage surface area that has been sculpted including, but not limited to, more than about 80% of the outer surface, more than about 90% of the outer surface, more than about 95% of the outer surface and in many cases essentially the entire outer surface. In addition, a work-product may have any number of geometries, including being planar over at least a portion of the work-product, rounded or arced, cylindrical and the like. In some embodiments, the work-product consists essentially of planar surfaces and is not cylindrical in shape or round in shape.

A work-product produced by the sculpting machining method, described herein, may have a surface roughness of 3.2 μm RA or less, 2.0 μm RA or less, 1.6 μm RA or less 1.0 μm RA or less, 0.8 μm RA or less, 0.4 μm RA or less, 0.2 μm RA or less and any range between and including the surface roughness values provided. A work-product produced by the sculpting machining method may not require any additional sanding, buffing or polishing.

In one embodiment, the method of sculpting a work-piece to produce a work-product comprises using a conventional CNC machine. A sculpting cutting tool may be inserted into the cutting tool holder and the CNC machine may be programmed to move the sculpting cutting tool to remove continuous ribbons from the work-piece.

The summary of the invention is provided as a general introduction to some of the embodiments of the invention, and is not intended to be limiting. Additional example embodiments including variations and alternative configurations of the invention are provided herein.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

### DETAILED DESCRIPTION OF THE ILLUSTRATED EMBODIMENTS

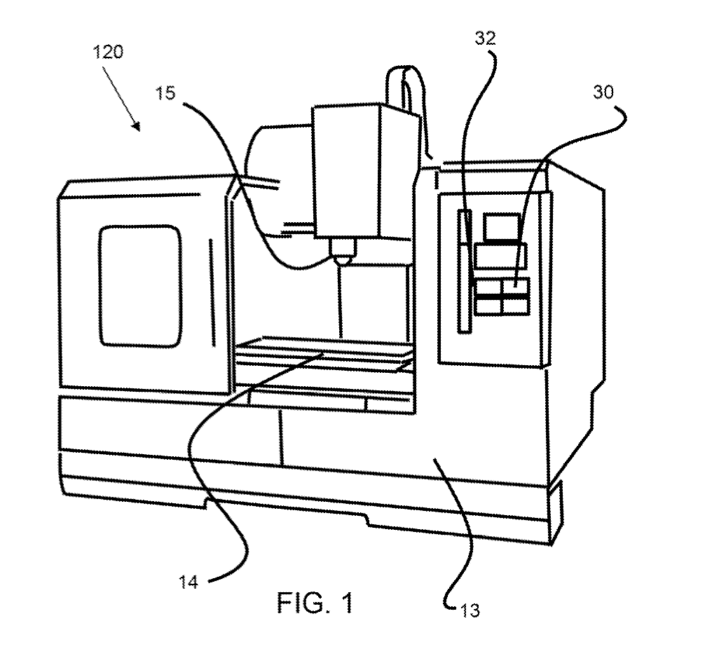

FIG. 1 shows a perspective view of an exemplary sculpting machine comprising a CNC machine, a cutting tool holder and work-piece restraint, as described herein.

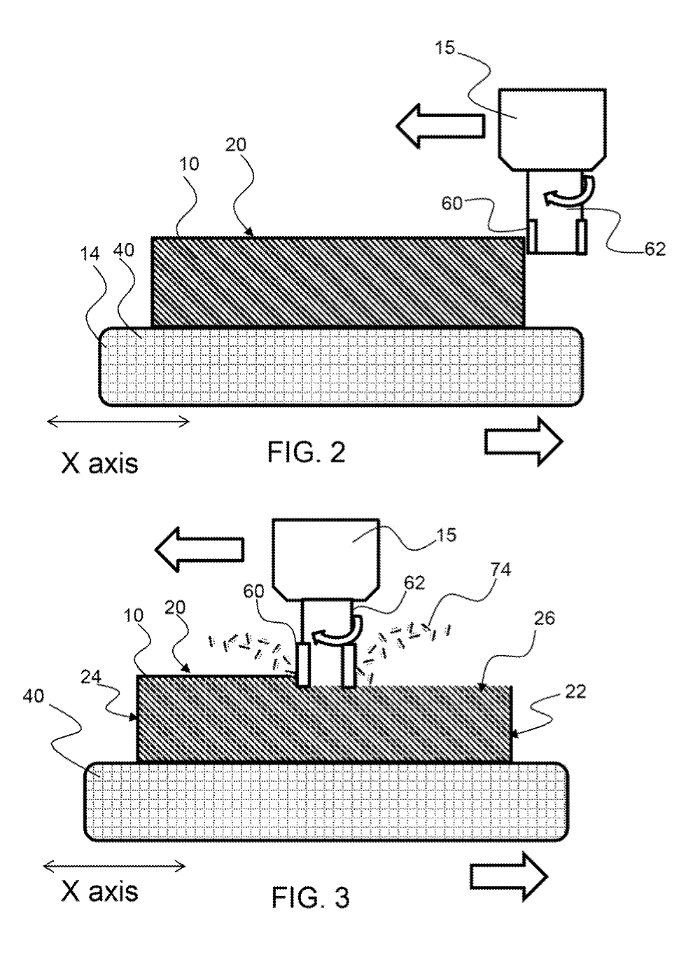

FIG. 2 shows a side view of a traditional spinning cutting tool configured to cut a portion of a work-piece.

FIG. 3 shows a side view of a traditional spinning cutting tool removing chips of material from a work-piece in an interrupted cut configuration.

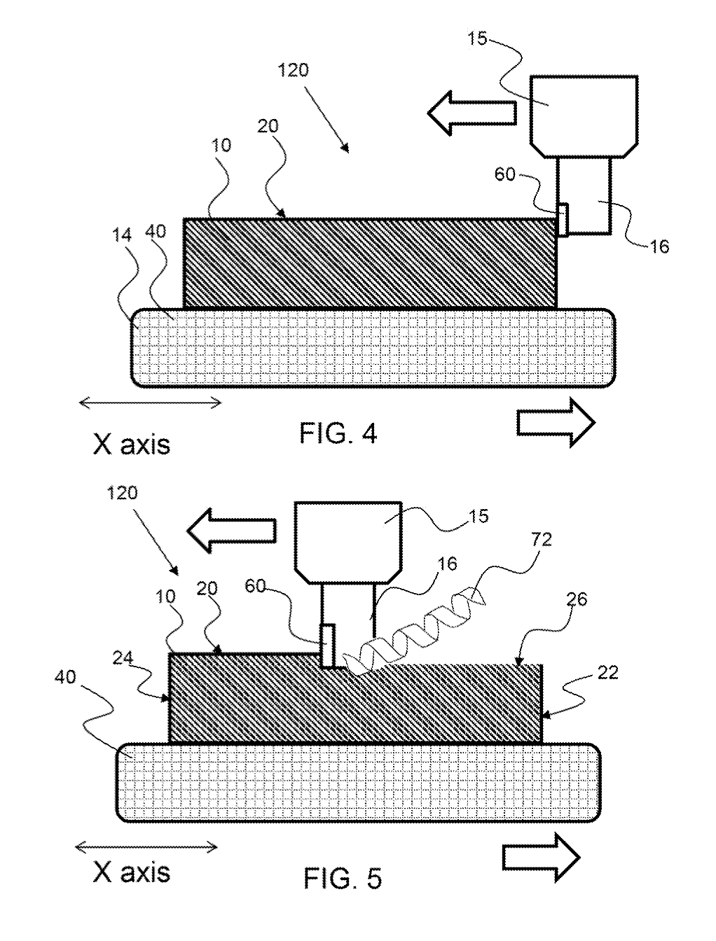

FIG. 4 shows a side view of an exemplary sculpting cutting tool configured to cut a portion of a work-piece.

FIG. 5 shows a side view of an exemplary sculpting cutting tool removing a continuous ribbon of material from a work-piece.

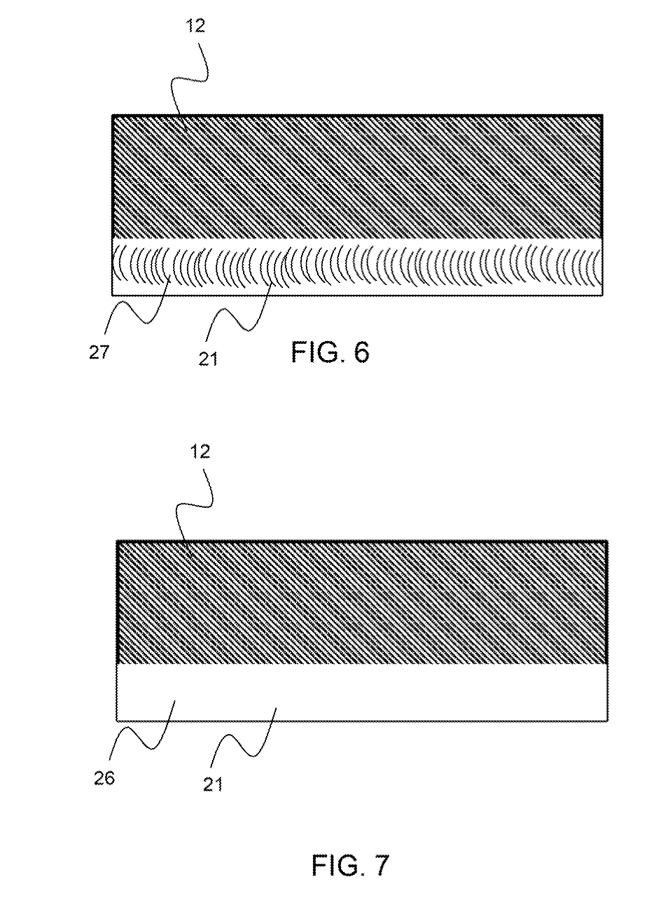

FIG. 6 shows a top-down view of the work-piece shown in FIG. 3 having an interrupted cut surface comprising striations from the spinning cutting tool.

FIG. 7 shows a top-down view of the work-piece shown in FIG. 5 having a smooth sculpted machine surface.

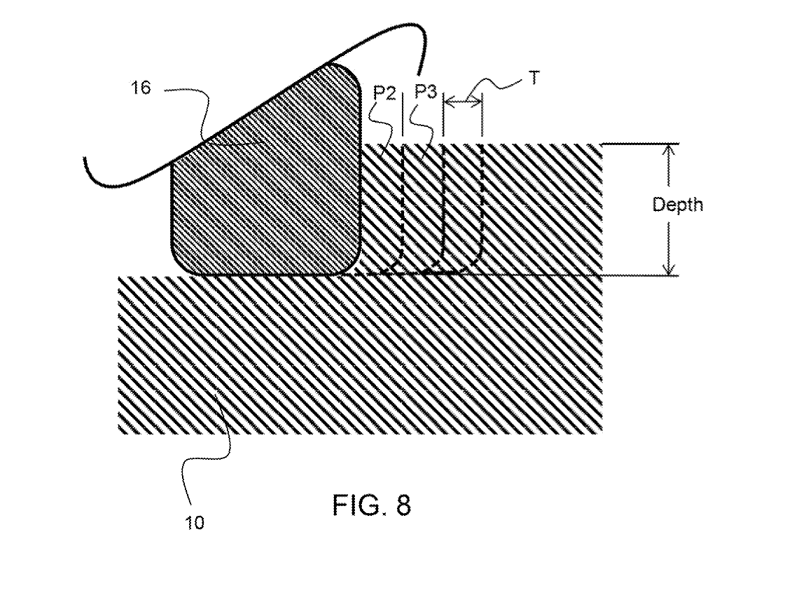

FIG. 8 shows a side view of a work-piece and an exemplary cutter removing material from the work-piece.

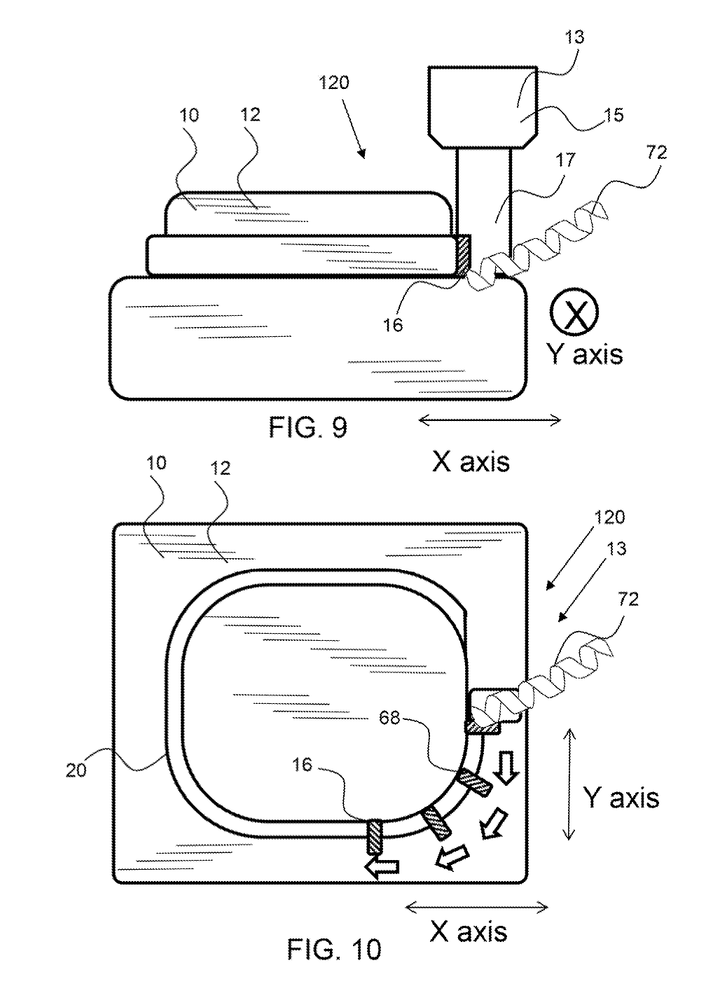

FIG. 9 shows a side view of an exemplary sculpting machine removing a continuous ribbon from a work-piece.

FIG. 10 shows a top-down view of the work-piece shown in FIG. 9

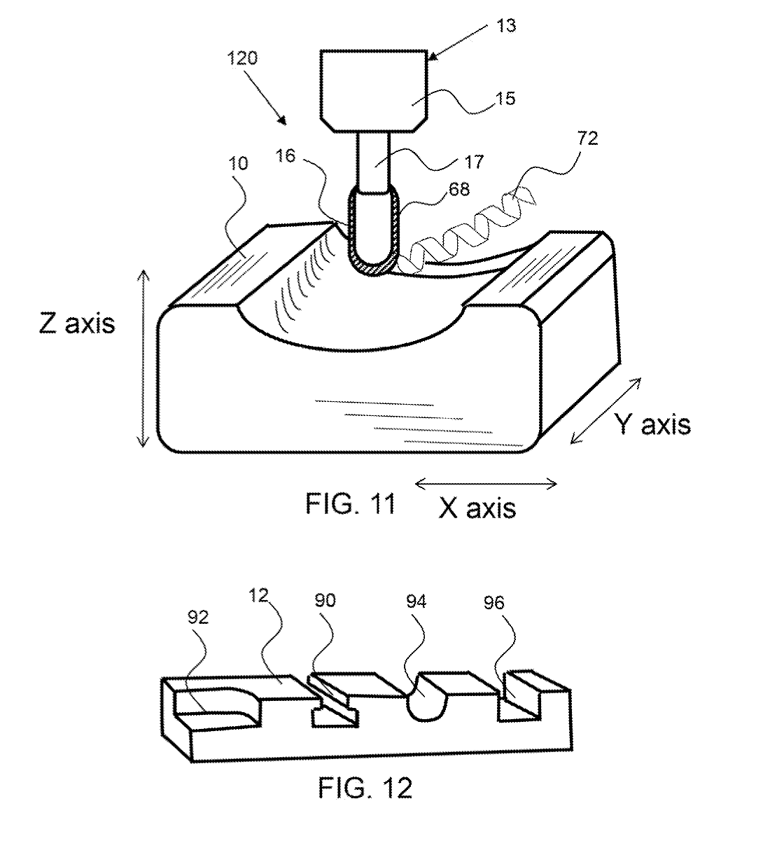

FIG. 11 shows a perspective view of an exemplary sculpting machine removing a continuous ribbon from a work-piece.

FIG. 12 shows a perspective view of an exemplary work-product having a, T-slot, square, round and shell type feature.

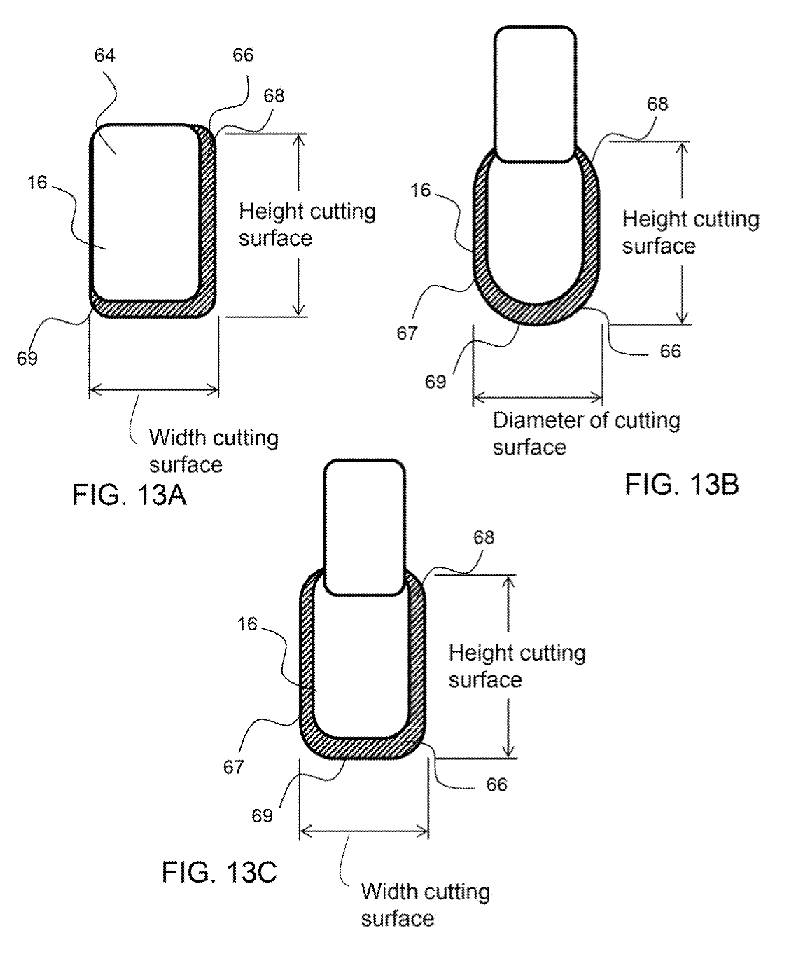

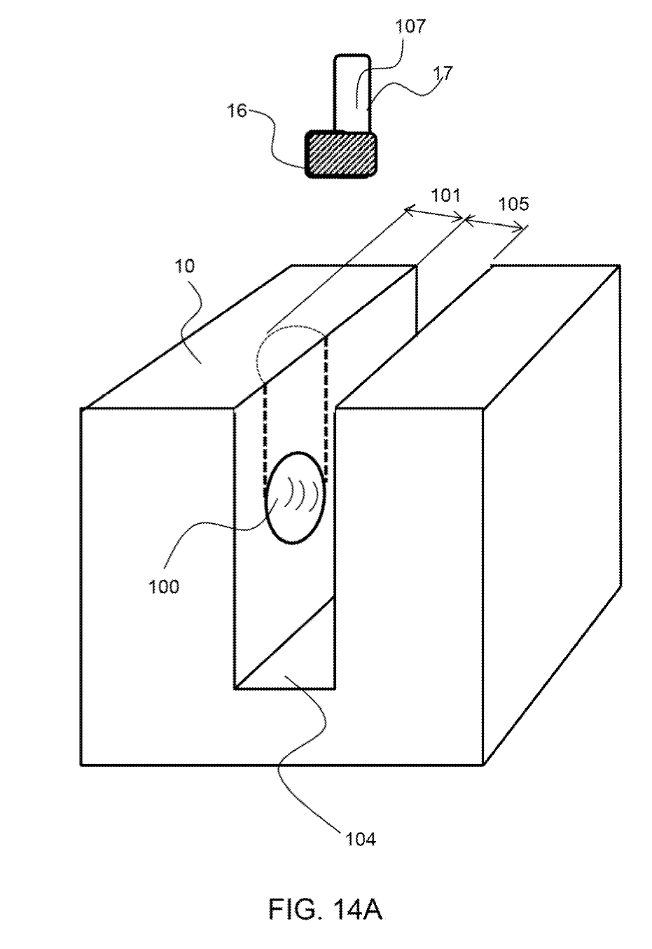

FIGS. 13A-13C show front views of different types of exemplary cutters.

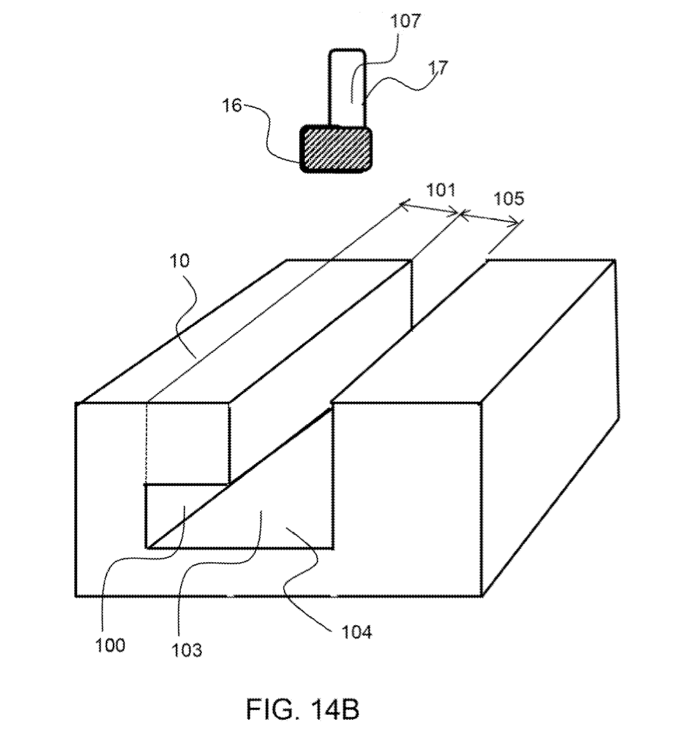

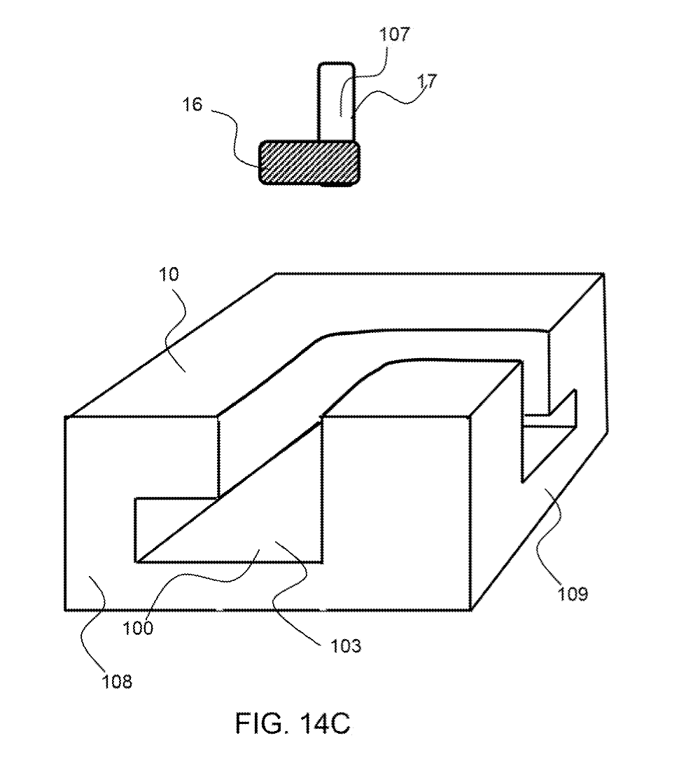

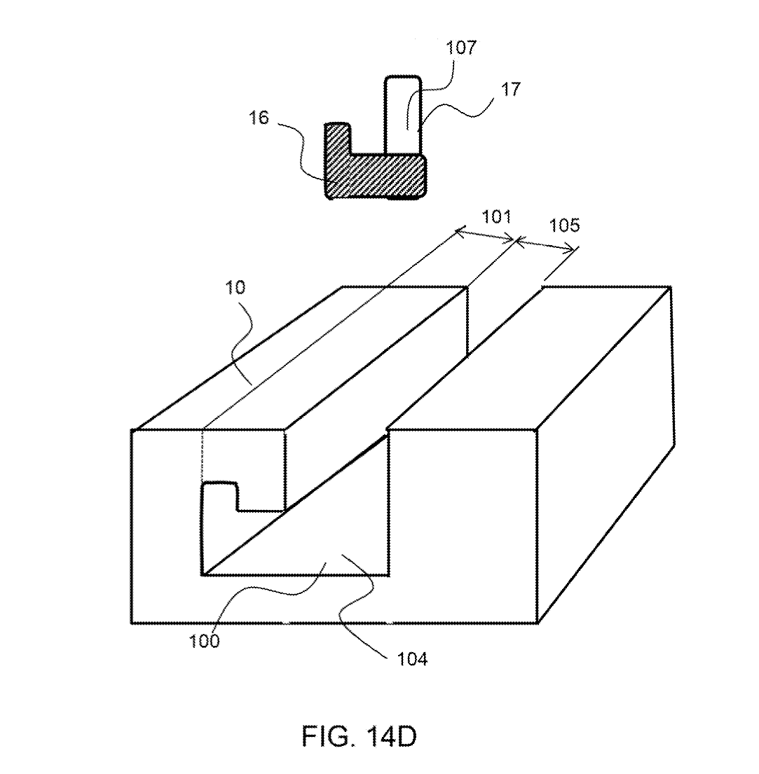

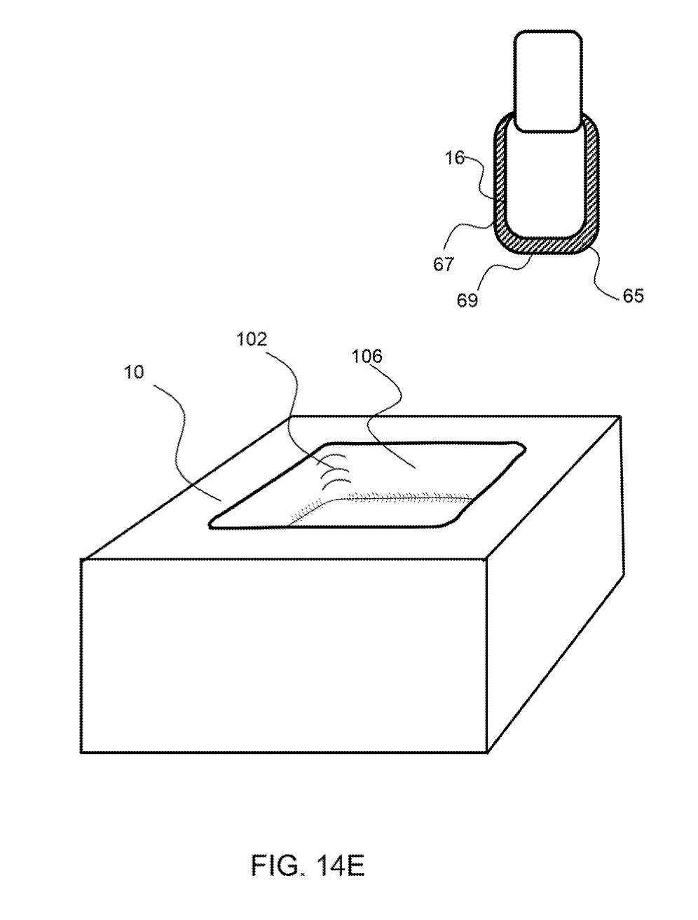

FIGS. 14A-14D, show perspective views of work-pieces having a variety of slots and slot depressions and exemplary cutters.

FIG. 14E shows a perspective view of a work-piece having a pocket cut-out from the top surface by the sculpting method as described herein.

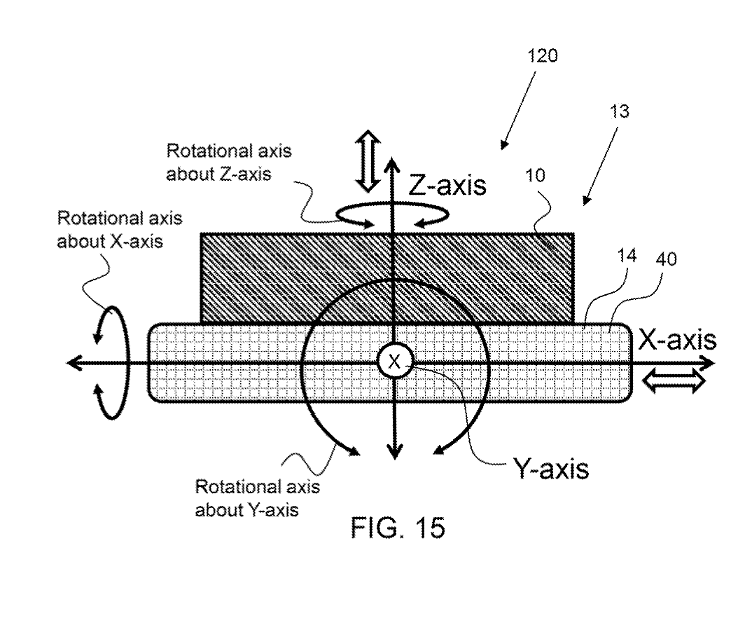

FIG. 15 shows a side view of an exemplary work-piece restraint having an X-axis, Y-axis, Z-axis and rotational axis of motion around each linear axis.

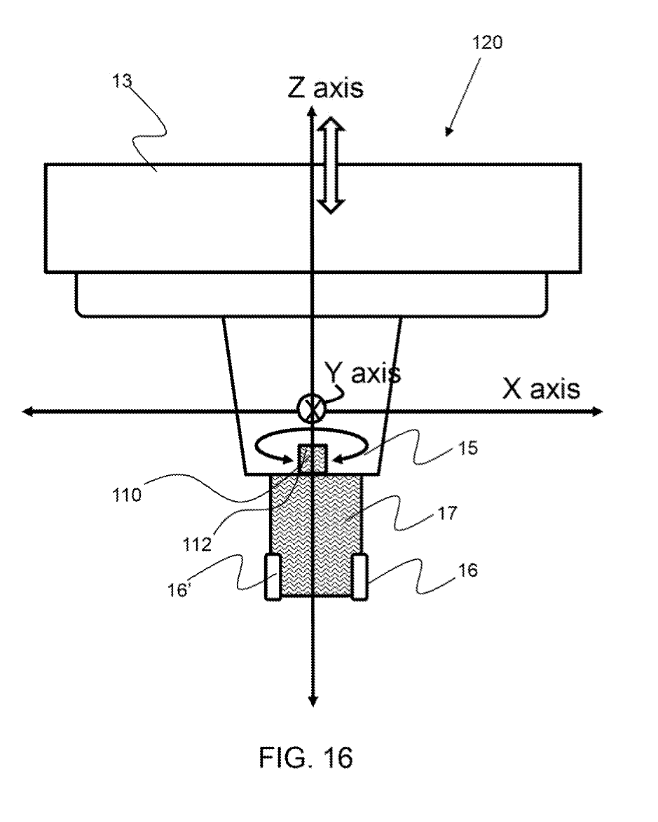

FIG. 16 shows a front view of an exemplary cutting tool holder body having an X-axis, Y-axis, Z-axis and rotational axis of motion around each linear axis.

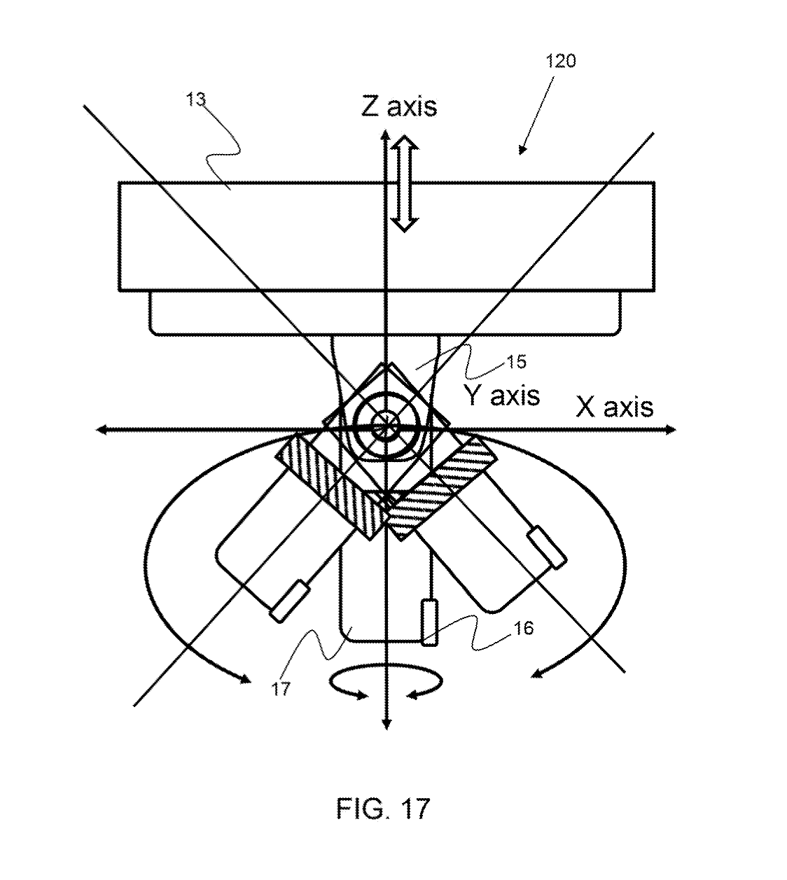

FIG. 17 shows a front view of an exemplary sculpting machine having a cutting tool holder body having an X-axis, Y-axis, Z-axis and rotational axis of motion about the Y-axis and the Z-axis.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, and improvements are within the scope of the present invention.

As shown in FIG. 1, an exemplary sculpting machine 120 comprises a CNC machine 13, control system 30 having a user input 32, a cutting tool holder 15 and a work-piece restraint 14. A user may input any number of instructions into the control system that will then move the work-piece restraint 14 and/or cutting tool holder 15 to produce a work-product. In one embodiment, the cutting tool holder is configured to only rotate and is not configured to spin. In another exemplary embodiment, a cutting tool holder may register the cutting tool in a specific rotational orientation whereby the sculpting machine control system 30 knows the rotational location of the cutter. In addition, the control system may then control and keep track of the rotational and linear position of the cutting tool and specifically the cutter position.

As shown in FIG. 2, a traditional spinning cutting tool 62 has a plurality of cutting implements 60, or cutters, configured to remove a layer of material from the outer surface 20 of the work-piece 10. The work-piece is restrained on the table 40 type work-piece restraint 14.

As shown in FIG. 3, the spinning cutting tool 62 is producing a plurality of chips 74, or discrete pieces of work-piece material, as it moves along the surface of the work-piece. This type of machining method produces an interrupted cut surface 27 type machined surface 21 as shown in FIG. 6. A plurality of striations are formed on the interrupted cut surface 27.

As shown in FIG. 4, an exemplary sculpting cutting tool 16 is configured to cut a continuous ribbon from a work-piece 10. The sculpting cutting tool may move in one direction as indicated by the arrow pointing left and/or the work-piece may move relative to the sculpting cutting tool 16. In some embodiments, both the sculpting cutting tool and the work-piece move at the same time or simultaneously.

As shown in FIG. 5, an exemplary sculpting cutting tool 16 is producing a continuous ribbon 72 from a work-piece 10. The cutting implement 60 stays in continuous contact with the work-piece as the cutting tool is moved relative to the work-piece surface 20. The cutting implement 60 is maintaining a tangential orientation with the work-piece surface. As shown in FIG. 7, the sculpted surface 26 type machined surface 21 is smooth and continuous.

As shown in FIG. 8 a cutter 16 is being moved in the plane of the figure to remove material from the work-piece 10. The depth of cut is shown and the width T of each successive pass P2, and P3 is shown. As described, any suitable depth and width may be removed from a work-piece depending on the type of material and cutter used. A depth of cut may include, but not be limited to, about 0.125 inch or more, about 0.25 inch or more, about 0.385 inch or more, about 0.5 inch or more, about 1.0 inch or more and any range between and including the depths provided. Likewise, the width removed in a pass of a cutter may include, but not be limited to, about 0.125 inch or more, about 0.25 inch or more, about 0.385 inch or more, about 0.5 inch or more, about 1.0 inch or more and any range between and including the widths provided.

As shown in FIG. 9, a cutter 16 is being moved across the Y-axis of a work-piece to remove a ribbon 72 of material therefrom. As shown in FIG. 10, the cutter is being moved in a controlled motion from a Y-axis of motion to an X-axis of motion. The cutter is maintained in contact with the work-piece throughout the transition from the Y-axis motion to the X-axis motion, thereby continuously sculpting off a layer of material. Put another way, the cutter is maintained in contact with a first plane of the material and a second plane of material to remove material in a continuous manner. These two planes are at right angles to each other or 90 degrees offset from each other. The edge 68 of the cutter 16 is maintained in a tangential orientation with the contoured outer surface 20 of the work-piece as a ribbon is removed. A sculpting machine may be configured to have any suitable length of controlled motion, or stroke-length, in the linear axes, Y-axis, X-axis and Z-axis, including, but not limited to, greater than about 1.0 inch, greater than about 5 inches, greater than about 12 inches, greater than about 24 inches, greater than about 36 inches, greater than about 48 inches, greater than about 60 inches, greater than about 100 inches and any range between and including the lengths provided. This stroke length may be derived from the range of motion of a cutting tool holder, a work-piece restraint or combinations thereof.

As shown in FIG. 11, an exemplary sculpting machine 120 is removing a continuous ribbon 72 from a work-piece 10. The cutting tool 16 is being moved along an arc but is maintaining a tangential orientation with the work-piece. The cutter is being moved by the sculpting machine in both the X-axis and Z-axis simultaneously.

As shown in FIG. 12, an exemplary work-product 12 has T-slot 90, square 92, round 93, and shell 96 type machined features. All of the types of cut-outs from a work-piece can be achieved with the method of the present invention.

FIG. 13A shows a cutter 16 having a height and a width. A cutter may have any suitable cutting surface or edge height or width including, but not limited to, about 6 inches or less, about 4 inches or less, about 2 inches or less, about 1 inch or less, about 0.5 inch or less, about 0.25 inch or less, about 0.125 inch or less and any range between and including the values provided. The cutter shown in FIG. 13A is an insert type cutter and one cutting surface is depicted by the crosshatched area. The cutting surface comprises two cutting edges along the corner of the cutter. The first edge 68 extends up along the vertical side of the cutter and the second edge 69 extends horizontally along the bottom side of the cutter. The two edges extend around a corner or right angle of the cutter. Any suitable shape of cutter may be used however. It is to be understood that an insert cutter may have a plurality of interchangeable cutting surfaces. For example, a second cutting surface may be catty-corner from the one shown, and two other cutting surface may be configured on the back side of the cutter insert. As shown in FIG. 13B, the cutter 16 has a round cutting surface at the extended end of the cutter having a diameter. The cutting surface extends up along the cutter to form two cutting surfaces extending up along the cutter. As shown in FIG. 13C, a cutter has three cutting surfaces 67, 68, and 69. The first and third cutting surfaces 68 and 67 extend down along the length of the cutter and the second cutting surface 69 is configured along the bottom of the cutter and extends between the first and third cutting surfaces.

As shown in FIG. 14A, a slot depression 100 is configured in a slot 104. Only the method of the present invention is capable of machining such a configuration when the slot width 105 is no more than twice that of the slot depression depth 101. With the method of the present invention, a slot depression may be cut away using a boot shaped cutter assembly 107 with a cutter 16 being positioned on one side of the cutter body 17.

As shown in FIG. 14B, an L-shaped slot 103 is cut-out from a work-piece 10, by an exemplary cutter 16. The L-slot could be easily cut out with the sculpting machine of the present invention and the cutting tool as shown. The boot shaped cutter 107, having a cutter that extends to one side of a cutter body or shank, would enable slot depression and L-slot formations in work-pieces.

As shown in FIG. 14C, a boot shaped cutter 107 is configured to cut-out the L-slot 103 and turn in a radius to enter a first side 108 of the work-piece and exit a second side 109 of the work-piece. The first and second sides of the work-piece are on different planes configured at 90 degrees from each other.

As shown in FIG. 14D, an exemplary cutter 16 is configured with a plurality of cutting surfaces to remove the slot 104 having the geometry shown. Any number and geometry of cutters can be envisioned to easily remove material from a work-piece in a manner not previously possible. A sculpting machine configured with the cutter shown in FIG's. 14A-14D provides capabilities not made possible by conventional CNC machines having spinning cutters.

As shown in FIG. 14E, an exemplary cutter 16 has a plurality of cutting surface that are configured to cut-out the pocket 106 as shown in the work-piece 10. The pocket has a radius 102 on the inside corners that match the cutter radius 65. This type of pocket is easily machined with a sculpting machine as described herein.

As shown in FIG. 15, a sculpting machine 120 comprises a work-piece restraint having an X-axis, Y-axis and Z-axis of linear motion, as well as a rotation axis of motion about each of these linear axis. Any suitable combination of controlled motion of a work-piece restraint may be configured into a sculpting machine as described herein. In some embodiments, the work-piece restraint is configured to move only in linear motion axes. In other embodiments, the work-piece restraint is configured to move in all three linear axes and rotate about one linear axis to provide 4 axes of controlled motion. In still another embodiment, the work-piece restraint is configured to move in all three linear axes and rotate about two of the linear axes to provide 5 axes of controlled motion. The sculpting machine may be configured to move the work-piece in two or more axes of controlled motion simultaneously. For example, a work-piece may be moved in both the X-axis and Y-axis, as shown in FIG. 10, to move the cutter about an arc. Likewise, a work-piece may be moved in at least one liner axis of controlled motion and rotated about one or more linear axes simultaneously.

As shown in FIG. 16, a sculpting machine 120 has a cutting tool hold 15 with three axes of linear motion, X-axis, Y-axis and Z-axis, and a rotation axis about the linear Z-axis. This configuration would provide for 4 axes of controlled motion. The cutting tool holder 15 is configured with a register feature 110, whereby the rotational orientation of the cutter body 17 may be set. The control system may control the motion of the cutter though a rotational register feature 110. A register feature may be a physical feature 112, as shown in FIG. 16, such a key slot and key or it may be an electronic feature. In still another embodiment, a register feature may be a light, whereby the sculpting machine passes the cutter by a light or through a light field to determine the exact location of the cutter. In yet another embodiment, a sculpting machine may move the cutter until it contacts the work-piece or any other physical object to determine the location of the cutter. A sensor or series of sensors may be used to determine when the cutter has contacted the physical object. A sensor may be configured in any suitable location including on the physical object or coupled with the cutting tool holder or cutting tool. In an exemplary embodiment, the control system of the sculpting machine would run the programmable work instructions that would include linear motion and rotational motion commands in series or simultaneously. These commands would be linked with the position of the cutter to properly move the cutter about a contour or over two or more planes of the surface of the work-piece. The work-piece and/or the cutter may be moved individually or simultaneously to perform the sculpting of the surface of the work-piece.

FIG. 17 show a sculpting machine 120 having a cutting tool holder 15 with three axes of linear motion, X-axis, Y-axis and Z-axis, and a rotation axis about both the linear Z-axis and linear Y-axis to provide 5 axes of controlled motion. Any suitable combination of controlled motion of cutting tool holder may be configured into a sculpting machine as described herein.

The sculpting machine of the present invention may comprise a sculpting tool holder assembly whereby the cutter is held in a rigid position and/or may be rotated about the work-piece. The cutter may be rotated to maintain an orientation of the cutter to the surface being cut away by the cutter from the work-piece. The sculpting machine may also comprise a spinning cutter holder as is typically used in a CNC mill. The two different types of cutter holders may automatically or manually changed over. For example, a spinning cutter may be used to remove some of the material from a work-piece and then the sculpting tool holder may be used to cut away and/or finish the work-piece to produce a work-product having high tolerances and a smooth surface finish.

In an exemplary embodiment, a sculpting machine is configured with a cutting tool holder that is configured to move in a plurality of axes of controlled motion to remove material from a work-piece. The cutter may be moved in any number of orientations and axes of controlled motion, including two, three, four, five or six to effectively carve away material from the work-piece in a sculpting manner. The weight of a cutting tool holder and cutting tool may be far less than the weight of a work-piece and/or work-piece restraint, thereby making it easier to quickly move the cutting tool holder, and cutter attached thereto, rapidly about the work-piece to produce the desired work-product. When the work-piece is heavy, quick motions of the work-piece in a back and forth or angular motion would create substantial forces that would require the machine to be designed for accommodating such forces.

In an exemplary embodiment, a sculpting machine to perform the sculpting requires a cutting tool that is similar in design to a lathe tool bit, the shank portion of which could be round, square, rectangular, or any shape necessary to support the cutting edge to give it the rigidity to perform its task and also adapt it to the sculpting machine or machine tool holder.

A sculpting machine, as described herein, can be constructed similar to that of a milling machine or CNC milling machine or CNC machining center with the tool being fixed to the Z-axis, or X-axis, or Y-axis, and able to be rotated clockwise or counterclockwise in order to achieve the optimal tool to work-piece geometry for cutting. This rotation can be accomplished manually or by the use of a servo motor or by the use of a spindle motor acting as a servo motor. By moving the X-axis, or Y-axis, or Z-axis, or any combination thereof, the cutter can be forced to interfere with the work-piece material thereby lifting ribbon-like peelings until the desired shape is achieved in the work-piece. The depth and width of the cut would be determined by the work-piece material, shape of the cutter, rigidity and power of the machine, as well as its limits in travel speed.

In an exemplary embodiment, the rotational position of the cutter would be synchronized with the direction of motion of the cutter in order to maintain the proper tool to work-piece geometry. In the case of conventional CNC machines, this synchronization would be accomplished by the CNC control. The CNC control would need to be able to read program codes to rotate the spindle to the proper degree of rotation for a given cut sequence. This would require the development of software to incorporate this additional degree of control that is not a capability of conventional machines. Another possibility would be for the CNC control to automatically rotate the cutter to the desired angle as a function of the forward direction of cutter motion. It should be noted, however, that the sculpting process could also be achieved without the degree of cutter rotation as previously described. The cutter could be rigidly locked in place and the work-piece could be rotated on a rotary fixture. The fixture would do the necessary rotating in order to maintain the proper tool to work-piece geometry. It should also be noted that cutter rotation relative to the work-piece is not necessary if all cutting passes are straight and parallel to each other. A most desired sculpting machine would be a sculpting/milling hybrid. The sculpting tools would be loaded into the machine in the same manner as the milling cutters. The spindle motor would supply the servo action necessary to maintain proper cutter to work-piece geometry, and if a part required a drilling, boring, or milling operation, the hybrid machine could easily accomplish all of these without having to transfer the work-piece to another machine.

The cutting tool holder and/or work-piece restraint may also be moved manually, or by some combination of manually and automatically, to sculpt a work-piece as described herein.

### Example 1

### Titanium

The sculpting method of machining offers a significant reduction in the cost of cutting tools. For example, a moderately sized aircraft component made from titanium metal was shown to consume a cost of $50 in cutters to produce just one part when using traditional milling method of machining. With the sculpting method of machining the cost was reduced to just $1 in cutter cost to produce the same part.

### DEFINITIONS

Sculpting, as used herein, is the removal of a ribbon of material from a work-piece by a cutting surface while the cutting surface is moved in two or more axes of controlled motion simultaneously.

A continuous layer, as used herein, is defined as a layer removed from a work-piece in a continuous fashion, whereby the cutter is in continuous contact with the work-piece to carve away a continuous ribbon from the work-piece.

A ribbon, as used herein, is a layer of material removed from a work-piece through the sculpting method described herein.

Tangent, as used herein, means that the cutting surface of the cutter is moved along the surface of the work-piece to substantially follow the contour of a desired cut shape including straight lines, arcs, circles and the like. One or more edges of a cutter may be maintained in substantially the same relative position with the work-piece as it is moved to sculpt away material from the work-piece.

Controlled motion, as used herein to describe motion of a cutter holder or work-piece restraint, means that the motion, including along one or more axes (X, Y, or Z) and/or rotational motion, is controlled by the computerized numerical control machine. Combination motions may be controlled by the computerized numerical control machine including two axes of motion simultaneously, including rotational and at least one linear axis motion simultaneously. Combination motions include two or more axes of controlled motion simultaneously and may be used to carve away complex shapes including arcs or curved surfaces. It is to be noted that controlled motion may include motion of both the work-piece and a cutter holder simultaneously, whereby the work-piece moves in a first axis of controlled motion and the cutter holder moves in a second axis of controlled motion.

Irregular shape, as defined herein, means that the work-piece or work-product is not a regular shape, such as rod or cylindrical shape.

Cutter, as used herein, may be an integral part of a cutting body or a cutter insert that is configured to be detachably attached to a cutter body. A cutter may have one or more cutting surfaces or edges. Ire one embodiment, a cutter has a plurality of cutting edges configured around a corner or right angle.

Rotating, as used herein to describe the motion of the cutter, means that the cutter may be rotated in relation to the surface of the work-piece to maintain contact and orientation of a cutter with the work-piece and that the cutter does not spin relative to the surface of the work-piece as is the case with spinning cutters used in traditional CNC machines. The cutter of the present invention may be configured to rotate 360 degrees, however.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

1. A sculpting method of machining a work-product comprising the steps of:
providing a work-piece;
providing a computerized numerical control machine comprising:
a work-piece restraint;
a control system configured to receive work instructions;
providing a cutting tool holder having at least one axis of controlled motion and configured to receive a cutting tool;
providing a cutting tool having at least one cutting surface;
placing said work-piece into said work-piece restraint;
securing said cutting tool in said cutting tool holder;
configuring said cutting tool to overlap said cutting surface with a surface of said work-piece; and
moving said cutting tool relative to said work-piece surface to cause said cutting surface to carve off a ribbon of work-piece material from said work-piece,
whereby said control system is configured to move said cutting tool relative to said work-piece restraint in two or more axis of controlled motion simultaneously to sculpt said work-piece by removing a ribbon of work-piece material from said work-piece, and during said sculpting said cutting surface is non-spinning relative to said work-piece.

2. The sculpting method of machining a work-product of claim 1, whereby the cutting surface is maintained in a tangential orientation to the work-piece.

3. The sculpting method of machining a work-product of claim 1, whereby the work-piece restraint is substantially non-spinning.

4. The sculpting method of machining a work-product of claim 1, whereby the work-piece restraint is a movable work-piece restraint having at least one axis of controlled motion.

5. The sculpting method of machining a work-product of claim 1, whereby the cutting tool holder is a movable cutting tool holder having at least two axes of controlled motion.

6. The sculpting method of machining a work-product of claim 5, wherein the cutting surface is maintained in continuous contact with the work-piece while the cutting tool holder is moved in at least one axis of controlled motion.

7. The sculpting method of machining a work-product of claim 1, wherein the cutting tool holder is configured to index the cutting tool to maintain a tangential position of the cutting surface relative to the work-piece.

8. The sculpting method of machining a work-product of claim 1, wherein the cutting tool comprises a removable cutting implement having at least one cutting surface.

9. The sculpting method of machining a work-product of claim 1, wherein the work instruction comprises a plurality of movements of the work-piece in a first axis of controlled motion and a second axis of controlled motion wherein the cutting surface is maintained in continuous contact with the work-piece during movement of the work-piece in said first and second axes of controlled motion to produce a continuous ribbon of work-piece material.

10. The sculpting method of machining a work-product of claim 1, wherein the work instruction comprises a plurality of movements of the cutting tool in a first axis of controlled motion and a second axis of controlled motion, wherein the cutting surface is maintained in, continuous contact with the work-piece during movement of the cutting tool in first and said second axes of controlled motion to produce a continuous ribbon of work-piece material.

11. The sculpting method of machining a work-product of claim 1, wherein the cutting tool has a cutting surface no larger than about 3 inches in length.

12. A work-product produced by a sculpting machining method comprising the steps of:
providing a work-piece;
providing a computerized numerical control machine comprising:
a work-piece restraint;
a control system configured to receive work instructions;
providing a cutting tool holder having at least one axis of controlled motion and configured to receive a cutting tool;
providing a cutting tool having at least one cutting surface;
placing said work-piece into said work-piece restraint;
securing said cutting tool in said cutting tool holder;
configuring said cutting tool to overlap said cutting surface with a surface of said work-piece; and
moving said cutting tool across said work-piece surface to cause the cutting surface to carve off a ribbon of work-piece material from said work-piece,
whereby said control system is configured to move said cutting tool relative to said work-piece restraint in two or more axis of controlled motion simultaneously to sculpt said work-piece by removing a ribbon of work-piece material from said work-piece and during said sculpting said cutting surface is non-spinning relative to said work-piece, to produce a work-product having an at least partially sculpted surface.

13. The work-product produced by a sculpting machining method of claim 12, whereby the cutting surface is maintained in a tangential orientation to the work-piece when said cutting tool moves relative to a surface of said work-piece in two or more axes of controlled motion simultaneously to remove a ribbon of work-piece material from said work-piece.

14. The work-product produced by a sculpting machining method of claim 12, whereby the work-piece restraint is a movable work-piece restraint having at least one axis of controlled motion.

15. The work-product produced by a sculpting machining method of claim 12, wherein the cutting surface is maintained in continuous contact with the work-piece while the work-piece restraint is moved in at least one axis of controlled motion.

16. The work-product produced by a sculpting machining method of claim 12 wherein the cutting tool is maintained in continuous contact with the work-piece while the cutting tool holder is moved simultaneously in two or more axis of controlled motion.

17. The work-product produced by a sculpting machining method of claim 12, wherein the work product is an engraving.

18. The work-product produced by a sculpting machining method of claim 12, wherein the work product is a sculpted art piece having a three-dimensional sculpted outer surface.

19. The work-product produced by a sculpting machining method of claim 12, wherein the work-product has a sculpted surface having a surface roughness (RA) of no more than 2 μm.

20. A sculpting computerized numerical control machine comprising:
a control system configured to receive work instructions;
a work-piece restraint;
a cutting tool holder having at least one axis of controlled motion and configured to receive a cutting tool having at least one cutting surface;
whereby said control system is configured to move said cutting tool relative to said work-piece restraint in two or more axis of controlled motion simultaneously to sculpt a work-piece, configured in said work-piece restraint, by removing a ribbon of work-piece material from said work-piece and during said sculpting said cutting surface is non-spinning relative to said work-piece.

21. The sculpting computerized numerical control machine of claim 20, whereby the work-piece restraint is substantially non-spinning.

22. The sculpting computerized numerical control machine of claim 20, wherein the cutting surface is maintained in continuous contact with the work-piece while the work-piece restraint is moved simultaneously in two or more axis of controlled motion.

23. The sculpting computerized numerical control machine of claim 20, wherein the cutting surface is maintained in continuous contact with the work-piece while the cutting tool holder is moved simultaneously in two or more axis of controlled motion.
